(19) United States
(12) Patent Application Publication
(10) Pub. No.: US 2010/0079293 A1
(43) Pub. Date: Apr. 1, 2010

(54) DEVICE FOR DETECTING A BODY FALLING INTO A POOL

(75) Inventor: Anthony Ginter, La Ciotat (FR)

Correspondence Address: MARSH, FISCHMANN & BREYFOGLE LLP, 8055 East Tufts Avenue, Suite 450, Denver, CO, 80237, US

(73) Assignee: M. G. International, La Ciotat (FR)

(21) Appl. No.: 11/993,678

(22) PCT Filed: Jul. 1, 2005
(86) PCT No.: PCT/FR05/01689

§ 371 Date: Dec. 21, 2007

(51) Int. Cl. G08B 23/00

(52) U.S. Cl. 340/573.6

(57) ABSTRACT

The invention concerns a device for detecting a body falling in a volume of water (20) of a pool comprising a probe (1) adapted to transmit aquatic waves propagated in the pool (20) and an electronic unit (4) adapted to receive and interpret electric signals representing pressure variations caused by the aquatic waves received by the probe. The probe (1) has a free end (11) immersed in the pool (20) and a substantially vertical axis (12). The device further comprises an immersed rigid obstacle (3) extending between the immersed end of the probe and the surface of the volume of water of the pool in a plane substantially perpendicular to the axis of the immersed probe. The rigid obstacle (3) enables disturbances caused by the surface waves to be eliminated from the measurements of pressure variations caused by the aquatic waves in the probe (1).

The present invention relates to a device for detecting the fall of a body into a pool such as a swimming pool, in particular the fall of a child or an animal. Such a device makes it possible to detect a body falling into a mass of water and to alert those nearby, by a siren, warning lights, or any other means to attract attention, in order to allow a rapid rescue.

The drowning of young children is a factor in numerous domestic accidents. Safety devices do exist, such as protection barriers surrounding the swimming pool, with an access gate. However, it is necessary to close the gate properly again every time it is passed through. Moreover, children of approximately three years of age can manage to open such a gate while they are still very exposed to drowning.

Safety devices also exist such as shelters, covers or shutters covering the swimming pool. Such a device is however unsightly and requires a complex removal operation before the use of the swimming pool.

The ideal solution for effectively preventing falls into the swimming pool while retaining easy access and a user-friendly character is to equip the swimming pool with a device for detecting the fall of bodies into the pool.

Such detection devices exist and are marketed. For example, the Aquapremium™, Aquasensor™, SensorPremium, SensorSolar, SensorElite, SensorEspio or SensorDomo devices marketed by the Applicant make it possible to detect the fall of a body into the pool of a swimming pool and to alert those nearby.

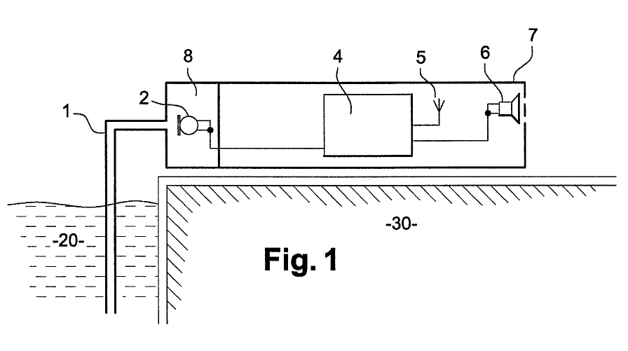

The known devices for detecting falls are generally constituted by a submerged probe in the pool and connected to an above-water housing. FIG. 1 describes a known detection device.

FIG. 1 shows a detection device arranged on the edge 30 of a pool 20, such as a swimming pool for domestic use for example. A probe 1 is submerged in the water of the pool and opens out into a compression chamber 8 arranged in a part of the housing 7 of the detection device. The compression chamber can be directly constituted by the immersed probe itself filled with air and acting as a compression chamber. The probe 1 is generally a tube at least partially filled with air, having one immersed free end and one end opening into the housing 7 of the submerged detection device. The tube 1 is thus adapted to transmit aquatic waves which are propagated in the pool 20 to the compression chamber 8. This chamber is hermetically sealed and detects the aquatic waves rising up the tube 1 as pressure variations. A pressure sensor 2, for example of the piezo-electric type, is arranged in the compression chamber 8 to convert the pressure variations into electrical signals. The pressure sensor 2 is connected to an electronic unit 4 arranged in the housing 7 of the detection device, separate from the compression chamber 8.

Any movement in the pool 20, and in particular the fall of a body, causes the formation of waves which lead to pressure variations in the compression chamber 8 of the fall detector. The sensor 2 converts these pressure variations to a voltage and the electronic circuit board 4 processes these signals in order to interpret whether they correspond to a fall. If necessary, the electronic circuit board 4 controls the transmission of a remote warning signal by triggering a siren 6 and/or by sending a signal to a remote warning unit via an aerial 5 or any other suitable telecommunication link.

The known detection devices have, however, the drawback of being sensitive to external disturbances and subject to untimely triggerings, due to the fact that the electronic circuit board interprets disturbance signals as a fall. Such disturbance signals can be due to the displacement of the robot cleaner, to the start of filtration, but also to rain or to waves caused by the wind. These disturbances can cause an untimely triggering of the alarm, which becomes annoying for those nearby and can prompt them to switch off of the device, with the risk of non-detection of a real fall. Most of these disturbances can be eliminated by adjusting the sensitivity of the detector.

On the other hand, surface waves, in particular due to the wind, strongly disturb the detection of underwater waves, as they alter the water level around the probe. In fact, the immersed probe transmits pressure variations due to the underwater waves by transmitting the pressure of the pool water rising in the tube onto the air filling said tube. This measurement is explained by well known physical phenomena, in particular by Archimedes' principle which states that any body partially or completely submerged in a fluid experiences an upthrust equal to the weight of the fluid it displaces, and by Boyle's law which states that at a constant temperature, the volume of a gas is inversely proportional to its pressure.

Thus, when the water level changes close to the probe, the pressure in the probe is altered and the measurement of amplitude of the underwater waves is subject to interference. This signal, originating from the measurement of the surface waves around the probe, are added to the signal, called the desired signal, generated by the pool during a fall. According to the phase shift of the interference and desired signals, the sensor can read an amplitude of an underwater wave as stronger or weaker than it is in reality. If the amplitude of the interference signal is subtracted from the amplitude of the underwater wave, detection of a real fall can be delayed and if the amplitude of the interference signal is added to the amplitude of an underwater wave, an untimely triggering of the alarm can result.

Adjustment of the sensitivity of the detector is unable to alleviate this phenomenon without risking failure to detect a real fall.

There is therefore a need to reduce the risks of untimely triggerings of the warning signal of the detection device due to the surface effects on the pool of the swimming pool while ensuring detection of a real fall into the water of the pool.

To this end, the invention makes provision to protect the probe from the effects of surface waves by creating a rigid obstacle between the immersed free end of the probe and the surface of the water. Thus, the pressure variations generated by the surface waves are not transmitted to the inside of the tube of the probe and the pressure detector then only detects the pressure variations due to aquatic waves propagating beneath the rigid obstacle.

The invention relates more particularly to a device for detecting a fall of a body into a mass of water of a pool comprising:

a probe adapted to transmit aquatic waves propagating in the pool, the probe having one free end immersed in the pool and a substantially vertical axis;

an electronic unit adapted to receive and interpret electrical signals representing pressure variations generated by the aquatic waves and picked up by the probe;

an immersed rigid obstacle extending between the immersed end of the probe and the surface of the mass of water of the pool in a plane forming a angle with the axis of the immersed probe.

According to an embodiment, the rigid obstacle is a plate comprising an opening through which the probe passes.

According to embodiment variants, the device according to the invention can comprise one or more of the following features:

the plate extends in a plane forming an angle comprised between 10° and 170° with the axis of the probe;

the plate is integral with the probe;

the plate is fixed to the pool;

the plate has a thickness comprised between 1 and 5 mm.

According to an embodiment, the rigid obstacle is formed by an angled portion of the probe.

According to a feature, the probe has a first part extending along the axis of the probe and a second part having at least one portion forming an angle with said axis, the second part being totally immersed.

According to another feature, the angled portion of the probe makes an angle comprised between 40° and 90° with the axis of the probe.

According to embodiments, the detection device according to the invention can comprise one or more of the following features:

the rigid obstacle has an area comprised between 10 and 350 cm²;

the probe is a tube at least partially filled with air, with a round, oval or trapezoid base;

the device comprises a compression chamber comprising a pressure sensor connected to the electronic unit;

the compression chamber is constituted by the probe hermetically sealed at its end opposite to the immersed free end; the compression chamber is situated in a housing of the device, the probe opening out into said compression chamber at its end opposite to the immersed free end.

The characteristics and advantages of the present invention will become apparent from the following description which is given as an illustrative and non-limiting example with reference to the drawings.

FIG. 1, already described, shows a known fall detection device;

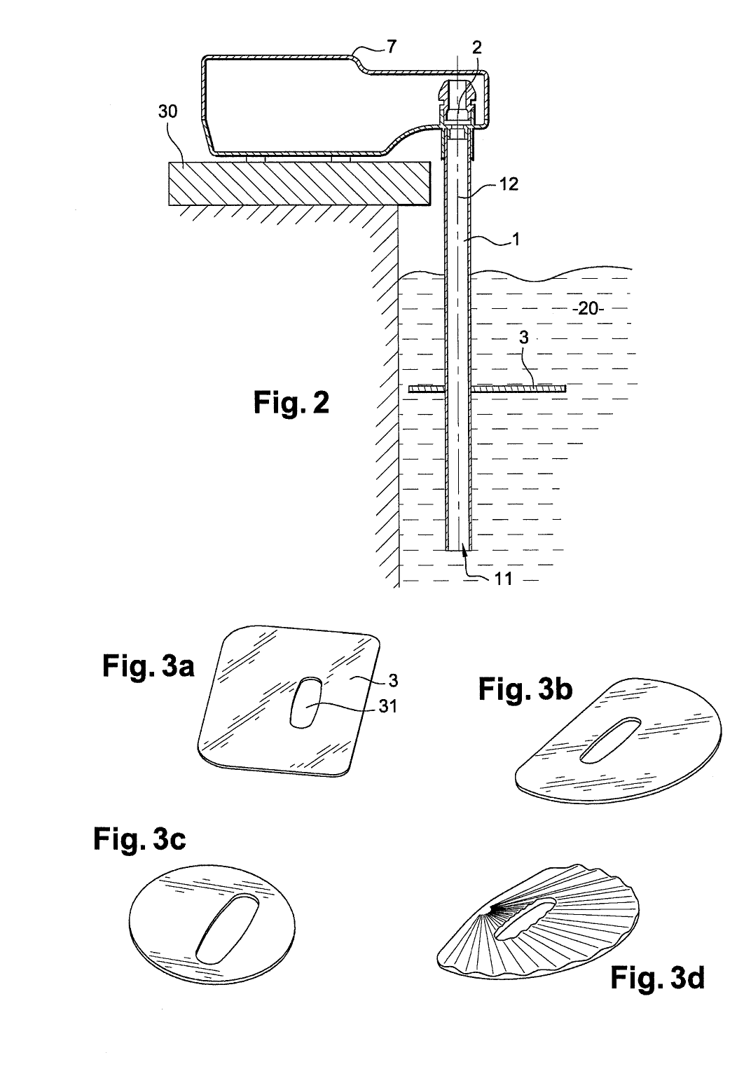

FIG. 2 is a diagram of a fall detection device of a first embodiment of the invention;

FIGS. 3a to 3d illustrate diagrammatic examples of surface wave detection obstacles which can be used on the device in FIG. 2;

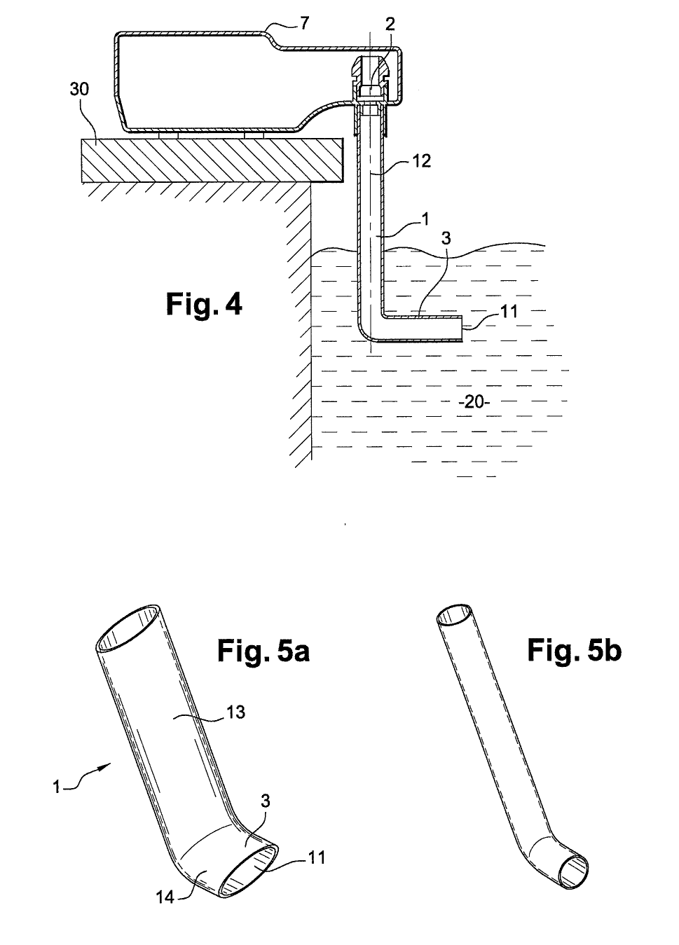

FIG. 4 is a diagram of a fall detection device of a second embodiment of the invention;

FIGS. 5a and 5b are diagrammatic examples of obstacles to surface wave detection which can be used on the device in FIG. 4.

Within the framework of the invention, by “aquatic waves” we mean any movement of a mass of water in the pool, whether on the surface (waves) or at depth (underwater waves), and the expression “signals generated by the pool” is used to designate the electrical signals representing aquatic waves (waves and underwater movements) propagating in the pool and picked up by the electronic circuit board of the fall detection device via the immersed probe.

FIG. 2 shows a detection device according to a first embodiment of the invention.

FIG. 2 shows a detection device arranged on the edge 30 of a pool 20, such as a swimming pool for domestic use for example. A probe 1 is submerged in the water of the pool and opens in a housing 7 of the detection device. The probe 1 is a tube at least partially filled with air having a free first end 11 immersed approximately 5 to 30 cm under the water level and a second end connected to the housing 7 of the device. The probe also has a substantially vertical axis 12. As explained above, the probe 1 must transmit pressure variations generated by the aquatic waves to a pressure sensor 2, these pressure variations being due to the pressure of the water on the air trapped in the tube according to Archimedes' principle as discussed above. It is therefore preferable for at least one part of the tube of the probe 1 to be vertical so that pressure variations can be detected with a sufficient amplitude according to this principle.

In FIG. 2, the compression chamber is directly constituted by the immersed probe 1 at least partially filled with air. The end of the tube 1 opposite to the immersed end is hermetically sealed and a pressure sensor 2 is placed directly at this end, for example in a gland which allows watertight sealing of the tube 1 while allowing an electrical connection to pass through. The pressure sensor 2 thus detects the aquatic waves rising in the tube 1 as pressure variations and converts these pressure variations into electrical signals. The pressure sensor 2 can be of the piezo-electric type and can be connected to an electronic unit (not shown) arranged in the housing 7 of the detection device.

The electronic unit is suited to receive and interpret the signals originating from the pressure sensor 2, i.e. the electrical signals representing the pressure variations in the probe 1 acting as a compression chamber, therefore representing the aquatic waves propagating in the pool.

The electronic unit is suited to interpreting the signals generated by the pool in that it can correlate for example the amplitude and frequency values of the electrical signal with a detection of a fall. The electronic unit can include a microprocessor chip according to a technique known per se.

Generally, the electronic unit is adapted to interpret an electrical signal received from the pressure sensor 2 as corresponding to a fall when said electrical signal is a sine wave having an amplitude greater than a predetermined threshold with a frequency in the region of 1 Hz. Such a signal is in fact characteristic of a fall of a body into the water. The electronic unit is then capable of controlling the triggering of a sound alarm arranged in the housing for example. The electronic unit can also trigger the transmission of a warning signal by a radio transmitter to a remote siren, for example in the house.

Now, as previously indicated, the surface waves can interfere with the measurement of the amplitude of the underwater waves and can cause either a delay in a detection of a fall or an untimely triggering of the alarm.

In fact, the aquatic waves are detected by the electronic unit of the detection device as a sinusoidal electrical signal. This sinusoidal signal is conventionally quantified as a half-wave, a half-wave corresponding to a half period of the sinusoidal signal, the peak of which exceeds a predetermined amplitude threshold. Thus, when the electronic unit receives an electrical signal from the pressure sensor the amplitude of which exceeds said predetermined threshold, it considers this event to be a valid item of information. If it detects a certain number of valid items of information which are successive and not missing within a predefined frequency range around 1 Hz, it interprets this as a fall.

If surface waves disturb the measurement of the aquatic waves, the pressure sensor 2 can transmit a pressure value different to the one generated by the aquatic wave alone and the electronic unit can then miss a valid half-wave item of information and delay a fall detection; or can erroneously consider a half-wave item of information as valid and unnecessarily trigger the alarm.

The invention therefore provides for the introduction of a rigid obstacle 3 between the immersed end 11 of the probe 1 and the surface of the water. This rigid obstacle 3 forms an angle with the axis 12 of the probe 1. For optimum effectiveness, the rigid obstacle 3 can extend in a plane substantially perpendicular to said axis 12, i.e. substantially horizontal. The rigid obstacle 3 can however be orientated along a plane other than the horizontal plane, for example in a plane forming an angle comprised between 10° and 170° with the axis 12 of the probe 1. The immersed free end 11 of the probe 1 is thus protected from pressure variations originating from surface waves and transmits in the tube of the probe 1 only the pressure variations originating from the aquatic waves propagating under the obstacle 3.

The obstacle 3 must be sufficiently rigid to reflect the aquatic waves coming from the surface without transmitting a pressure variation to the mass of water situated below. The shape and size of the obstacle 3 are chosen for effective protection of the immersed free end 11 of the tube.

In the embodiment shown in FIG. 2, the rigid obstacle is constituted by a plate 3 positioned around the probe 1 and extending in a plane perpendicular to the axis 12 of the probe. The plate 3 is therefore substantially parallel to the surface of the water and can send the pressure variations due to the surface waves back upwards, without transmitting a pressure variation downwards in the direction of the free end 11 of the probe 1. The plate 3 can be fixed directly to the tube of the probe 1 and/or fixed to the wall of the pool 20 and/or to the housing 7 of the device.

FIGS. 3a to 3d show different possible plate shapes for constituting the rigid obstacle. It is understood that other shapes can be envisaged which are different from the four forms shown.

The plate 3 can be made of plastic, for example ABS (Acrylonitrile Butadiene Styrene) or polycarbonate, and can be obtained for example by injection moulding in a manner which is known per se. The plate 3 has an opening 31 allowing the plate 3 to be positioned around the tube of the probe 1 as shown in FIG. 2. The opening 31 is preferably chosen with a periphery corresponding to the shape of the probe 1, i.e. the plate 3 will have a round opening 31 if the probe is cylindrical with a circular base or an oval or trapezoid opening if the probe is cylindrical with an oval or trapezoid base. Any other shape of opening 31 can be envisaged, depending on the shapes of the probe used for the detection devices. Moreover, the dimensions of the opening 31 are preferably chosen to fit the periphery of the probe in order not to allow the water to pass through the opening 31 when the plate 3 is placed around the probe. The plate 3 can thus be clipped onto the tube of probe 1, for example in a groove provided for this purpose; the plate can also be bonded to the tube of the probe and permanently attached on the tube. The plate 3 can also be placed around the tube of the probe 1 and fixed elsewhere, for example with a rod connecting the plate to a fixing system, for example a suction cup, on the wall of the pool or under the housing of the device.

The plate 3 is sufficiently rigid and extended to ensure its function as an obstacle to the pressure variations due to the surface waves. The plate can have a thickness comprised between 1 and 5 mm and extend over a surface having an area comprised between 10 and 350 cm². The shape of the plate —round, square, oval, an arc of a circle, etc depends on the shape and size of the detection device on which it is placed, and the distance between the probe and the wall of the pool.

FIG. 3d shows a plate having an upper surface, i.e. facing the surface of the water, with ribbing. A surface of this type allows the aquatic waves propagating from the surface to be attenuated instead of sending them back up to the top of the pool.

FIG. 4 describes a detection device according to a second embodiment of the invention. The elements identical to FIG. 2 bear the same reference numbers.

In the embodiment shown in FIG. 4, the rigid obstacle is constituted by an angled portion of the tube of the immersed probe 1. The tube is generally made of rigid plastic and is thus able to constitute the obstacle without the need for the use of an additional piece.

The probe 1 still has a substantially vertical axis 12 as described previously and for the same reasons of effective measurement of the amplitude of the aquatic waves by pressure variation. The immersed free end 11 of the probe 1, however, is not situated within the extension of this vertical axis 12. The probe 1 has a portion forming an angle with the vertical axis of pressure of the water on the air trapped in the tube. The upper wall 3 of this portion of tube forms a rigid obstacle between the surface of the water and the free end 11 of the tube. According to the models of probes used, the upper wall of the angled portion of the tube can form an angle comprised between 40° and 90° with the axis 12 of the probe 1.

FIGS. 5a and 5d give two example of obstacles 3 constituted by the probe 1 itself. It is understood that other forms can be envisaged.

The probe 1 has a first part 13 intended to extend along a substantially vertical axis 12 when the probe is submerged in the pool (FIG. 4). This first part 13 is intended to transmit the pressure variations generated by the aquatic waves to the sensor 2, according to the physics principles stated above. The probe 1 also has a second part 14 which has an elbow joint and at least one portion 3 forming an angle with the above-mentioned vertical axis. Preferably, the rigid portion 3 is substantially perpendicular to the vertical axis 12, but the portion of tube forming the obstacle 3 can form an angle comprised between 40° and 90° with the axis of the probe. The second part 14 is intended to be totally immersed when the probe is submerged in the pool (FIG. 4). The upper surface of the angled portion 3 of the probe then constitutes an obstacle to the transmission of pressure variations due to the surface waves to the immersed free end 11 of the probe 1.

Although not shown, the angled portion of the probe can have a hook- or S-shaped portion having several elbow joints. Whatever the shape envisaged, the probe 1 must have a substantially vertical part for the transmission of pressure variations to the sensor 2 and a totally immersed part forming an angle with the vertical, preferably a right angle. The immersed free end 11 of the probe can be situated at one end of the angled portion, as shown in FIG. 4, or at one end of another vertical part of the probe, the angled portion being situated in a median zone of the probe.

The angled portion 3 in fact constitutes a rigid obstacle in the meaning of the invention, with a surface substantially perpendicular to the axis 12 of the probe situated between the surface of the water and the immersed end 11 of the probe. This angled portion 3 is preferably sufficiently long to ensure that the surface aquatic waves effectively stop propagating towards the free end 11 of the probe, for example a length of the angled portion comprised between 5 cm and 20 cm is suitable for a different shape of probe to form a rigid obstacle having an area comprised between 10 and 350 cm².

The fall detection device according to the invention thus allows a measurement of the pressure variations generated by the aquatic waves propagating in the pool without interference with these measurements by the pressure variations generated by a variation in the water level due to surface waves. Thus the detection of a body falling into the pool is optimized and the untimely setting off of the alarm reduced.

Of course, the present invention is not limited to the embodiments described by way of example. In particular, it is possible for the probe 1 not to be hermetically sealed at its upper end and to open into a compression chamber situated in the housing of the detection device. Moreover, other shapes for the obstacles 3 can be envisaged, in particular an S-shape or hook-shape of the probe 1, instead of the L-shape shown.

1-14. (canceled)

15. A device for detecting the fall of a body into a mass of water of a pool comprising:
a probe adapted to transmit aquatic waves propagating in the pool, the probe having a free end immersed in the pool and a substantially vertical axis;
an electronic unit adapted to receive and interpret electrical signals representing pressure variations generated by aquatic waves and picked up by the probe;
an immersed rigid obstacle extending between the immersed end of the probe and a surface of a mass of water in the pool in a plane forming an angle with an axis of the immersed probe.

16. The detection device according to claim 15, wherein the rigid obstacle is a plate comprising an opening through which the probe passes.

17. The detection device according to claim 16, wherein the plate extends in a plane forming an angle comprised between 10° and 170° with the axis of the probe.

18. The detection device according to claim 16, wherein the plate is integral with the probe.

19. The detection device according to claim 16, wherein the plate is fixed to the pool.

20. The detection device according to claim 16, wherein the plate has a thickness comprised between 1 and 5 mm.

21. The detection device according to claim 15, wherein the rigid obstacle is formed by an angled portion of the probe.

22. The detection device according to claim 21, wherein the probe has a first part extending in the axis of the probe and a second part having at least one portion forming an angle with said axis, the second part being totally immersed.

23. The detection device according to claim 22, wherein the angled portion of the probe forms an angle comprised between 40° and 90° with the axis of the probe.

24. The detection device according to claim 15, wherein the rigid obstacle has an area comprised between 10 and 350 cm².

25. The detection device according to claim 15, wherein the probe is a tube at least partially filled with air with a round, oval or trapezoid base.

26. The detection device according to claim 15, wherein the detection device comprises a compression chamber comprising a pressure sensor connected to the electronic unit.

27. The detection device according to claim 26, wherein the compression chamber is constituted by the probe hermetically sealed at its end opposite to the immersed free end.

28. The detection device according to claim 26, wherein the compression chamber is situated in a housing of the device, the probe opening into said compression chamber by its end opposite to the immersed free end.
